(19) United States
(12) Patent Application Publication
(10) Pub. No.: US 2018/0097758 A1
(43) Pub. Date: Apr. 5, 2018

(54) Method and process for request and approval transmission and management via electronic mail attachment

(71) Applicant: Philip Ibrahim Benson, London (GB)

(72) Inventor: Philip Ibrahim Benson, London (GB)

(21) Appl. No.: 15/283,411

(22) Filed: Oct. 2, 2016

(51) Int. Cl. H04L 12/58

(52) U.S. Cl. CPC H04L 51/08; H04L 51/12

(57) ABSTRACT

A method for transmitting and viewing electronic requests as an email attachment from a sender to at least one recipient by email who can approve, request modification or reject requests within email clients.

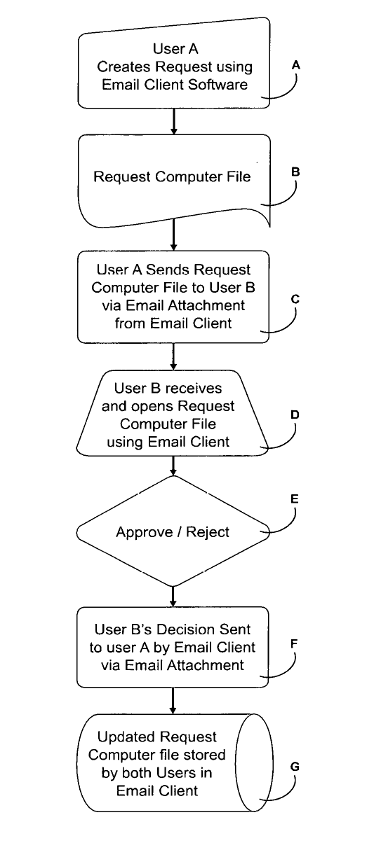

### STATEMENT REGARDING FEDERALLY SPONSORED RESEARCH OR DEVELOPMENT

n/a

### REFERENCE TO A SEQUENCE LISTING, A TABLE, OR A COMPUTER PROGRAM, LISTING COMPACT DISC APPENDIX

n/a

### BACKGROUND OF THE INVENTION

Individuals, departments and organisations use emails and paper documents to make requests of all types that require approval from other individuals, departments and organisations. The requests and approvals, most often by email and paper, can be difficult to recall from busy email inboxes and document filing cabinets and email chains can be forked, making it difficult to track changes or have clear sight on what has been approved. The present invention makes this process of making requests, sending requests, approving requests and storing the request and outcome simpler and clearer.

### BRIEF SUMMARY OF THE INVENTION

The present invention is a request and approve process via the distributed exchange of a computer file via email attachment by a typical computer user. The present invention is not limited to the use of one file format, the only limitation is the ability of the users' computer software to read the computer files. The computer file is created by a user, ‘User A’, containing the details of the request, User A sends the file to another user, ‘User B’, by email attachment; and then User B receives the computer file request via email attachment, opens the computer file and then has the option to approve, reject, modify, or request modification of the request and for this to be sent back to User A automatically by email attachment by User B's computer software. The response and any modifications will be stored by both users, other parties can be copied into the request and those recipients will receive the request file.

### BRIEF DESCRIPTION OF THE SEVERAL VIEWS OF THE DRAWING

The sole drawing is a flow diagram of the process of this invention showing the sequential steps taken to complete the process of requesting, approving and storing of approvals.

Detail A shows the action of creation of a request, the Request Computer File, using email client software or other such suitable software

Detail B shows the Request Approval File item that has been created

Detail C shows the action of the sending the Request Approval File from the requester to the approver

Detail D shows the Request Approval File being received by email attachment, opened and viewed using suitable software by the approver

Detail E shows the decision being made by the Approver

Detail F shows the action of the approver sending their decision to the requester as a modified Request Approval File by email attachment

Detail G shows the Request Computer File is stored by the approver and the requester and that this can be retrieved at a later time to view the details of the request

### DETAILED DESCRIPTION OF THE INVENTION

A typical computer user, User A, using a software program, such as an email client, creates a request; the request can be for anything in nature and the details of the request will only be limited by the file format and/or the software program used to compose the request and will be given a unique ID by the computer software. The request computer file is then be sent to another user, User B, by email attachment in accordance to the MIME Protocol.

The recipient of the request computer file, User B, can open the file using a suitable software program, such as an email client, User B will see the details of the request and have a choice of responses.

User B can accept the request, reject the request, make an amendment to the request, or request an amendment. User B will be able to choose the response by use of ‘buttons’ provided in the software program being used to open the request computer file.

The response to the request will be sent back to User A as a modified request computer file with the same unique ID by email attachment, and both the sender and the receiver of the request will have a copy of the request and the response. As the request computer file is sent by email, it is possible to copy other recipients into the email and thus these other parties would also have copies of the request computer file.

The software program used to send and receive the Electronic Approval Process request will also be able to store the request and responses to be reviewed at anytime. In software such as an email client, this could be a separate tab within the software.

1. A computer-implemented system and/or method for the creation of a computer file containing details of a request

2. A computer-implemented system and/or method for the distribution of the request computer file by email attachment in accordance with the MIME Protocol to a recipient or multiple recipients

3. A computer-implemented system and/or method for the accepting or rejecting, and possibly the modification or request of modification of the request by the recipient

4. A computer-implemented system and/or method for the exchange of the response of the recipient to the requester by email

5. A computer-implemented system and/or method for the storage of the computer file with the details of the request and the response that can be stored by the requester and the approver and any email recipient of the computer file.
